(19) United States
(12) Patent Application Publication
(10) Pub. No.: US 2026/0311530 A1
(43) Pub. Date: Oct. 8, 2026

(54) Remote Door Locking System and Method of Use

(71) Applicant: Scott Charles Denton, Las Vegas, NV (US)

(72) Inventor: Scott Charles Denton, Las Vegas, NV (US)

(21) Appl. No.: 19/636,570

(22) Filed: Apr. 1, 2026

Related U.S. Application Data
(60) Provisional application No. 63/784,786, filed on Apr. 7, 2025.

(51) Int. Cl. G07C 9/00

(52) U.S. Cl. CPC G07C 9/00571; G07C 9/00944; G07C 2209/08; G07C 2209/62

(57) ABSTRACT

A remote door locking system and method of use are provided. The system includes an input and indicator assembly configured to receive input and provide an indication of whether a door is locked or unlocked. The system also includes a door assembly having the door, a lock configured to lock the door, and an actuator configured to move the lock between an unlocked position and a locked position, while allowing normal mechanical exit. The system further includes a logic relay circuit configured to actuate the actuator to move the lock from the unlocked position to the locked position when the input is received at the input and indicator assembly.

### CROSS REFERENCE TO RELATED APPLICATIONS

This application claims the benefit of U.S. Provisional Application No. 63/784,786, filed on Apr. 7, 2025, which application is incorporated herein by reference in its entirety.

### FIELD

The present technology is generally related to security locking systems for doors and more particularly, to a wired remote door locking system.

### BACKGROUND

Businesses such as fast-food restaurants, restaurants, retail stores, etc. may experience dangerous situations in which violent incidents may occur near the premises, or a violent individual may try to enter the premises. In such situations, conventional security systems or solutions such as cameras, conflict resolution training, or relying on local law enforcement may not provide enough safety or may not provide such safety fast enough. Other conventional solutions such as armed security guards or wireless systems may be expensive to implement. Thus, it is desirable to have a security system that is effective at providing safety to customers and workers within a building while remaining cost effective, easy to use, and easily and quickly deployable.

### SUMMARY

Example aspects of the present disclosure include:

A remote door locking system according to at least one embodiment of the present disclosure comprises an input and indicator assembly configured to receive input and provide an indication of whether a door is locked or unlocked; a door assembly having the door, a lock configured to lock the door, and an actuator configured to move the lock between an unlocked position and a locked position; and a logic relay circuit configured to actuate the actuator to move the lock from the unlocked position to the locked position when the input is received at the input and indicator assembly.

Any of the aspects herein, wherein the logic relay circuit is further configured provide the indication that corresponds to door being locked.

Any of the aspects herein, wherein the input and indicator assembly includes an input receiver and an indicator.

Any of the aspects herein, wherein the input receiver includes a button connected to a switch in a normally closed position, and wherein pressing the button moves the switch from the normally closed position to an open position.

Any of the aspects herein, wherein the indictor includes at least one of a first LED and a second LED, a dual action LED, or a series of LEDs.

Any of the aspects herein, wherein the logic relay circuit includes a control relay that controls power to an actuator circuit that powers the actuator via a first contact and that controls power to the first LED and the second LED via a second contact.

Any of the aspects herein, wherein the first contact is in an closed switch position and the second contact is in an open switch position for the first LED and in a closed switch position for the second LED when the input receiver has not received the input, and wherein the lock is in an unlocked position, the first LED is unlit, and the second LED is lit.

Any of the aspects herein, wherein the first contact is in an open switch position and the second contact is in a closed switch position for the first LED and in an open switch position for the second LED when the input receiver has received the input, and wherein the lock is in a locked position, the first LED is lit, and the second LED is unlit.

Any of the aspects herein, wherein the first LED is a red LED and the second LED is a green LED.

Any of the aspects herein, wherein the green LED indicates that the door is unlocked and the red LED indicates that the door is locked.

Any of the aspects herein, wherein the door assembly includes two or more door assemblies and the input and indicator assembly includes two or more input and indicator assemblies.

Any of the aspects herein, further comprising a power source configured to provide power to the logic relay circuit, the input and indicator assembly, and the actuator.

Any of the aspects herein, wherein the input and indicator assembly, the logic relay circuit, and the door assembly are hardwired.

A method of locking a door from a remote location according to at least one embodiment of the present disclosure comprises receiving input at an input and indicator assembly; actuating an actuator by a logic relay circuit based on the input received, wherein actuating the actuator moves a lock from an unlocked position to a locked position to lock a door; and providing an indication that the door is locked from the input and indicator assembly.

Any of the aspects herein, wherein the input and indicator assembly includes an input receiver and an indicator.

Any of the aspects herein, wherein the input receiver includes a button connected to a switch in a normally closed position, and wherein pressing the button moves the switch from the normally closed position to an open position.

Any of the aspects herein, wherein the indictor includes at least one of a first LED and a second LED, a dual action LED, or a series of LEDs.

Any of the aspects herein, wherein the logic relay circuit includes a control relay that controls power to an actuator circuit that powers the actuator via a first contact and that controls power to the first LED and the second LED via a second contact.

Any of the aspects herein, wherein the first contact is in an closed switch position and the second contact is in an open switch position for the first LED and in a closed switch position for the second LED when the input receiver has not received the input, and wherein the lock is in an unlocked position, the first LED is unlit, and the second LED is lit.

Any of the aspects herein, wherein the first contact is in an open switch position and the second contact is in a closed switch position for the first LED and in an open switch position for the second LED when the input receiver has received the input, and wherein the lock is in a locked position, the first LED is lit, and the second LED is unlit.

Any of the aspects herein, wherein the first contact is in an open switch position and the third contact is in a normally open or closed position and connected to an auxiliary device configured to sense a signal or change in a circuit's normally open or normally closed state, such as an alarm panel, audible or silent alarm, video recording system, or any auxiliary relay connected to lights, strobes, audible loud speaker, that can broadcast live or recorded commands or instructions to deter the person(s) trying to enter the location, etc.

The details of one or more aspects of the disclosure are set forth in the accompanying drawings and the description below. Other features, objects, and advantages of the techniques described in this disclosure will be apparent from the description and drawings, and from the claims.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Z₀, the phrase is intended to refer to a single element selected from X, Y, and Z, a combination of elements selected from the same class (e.g., X₁ and X₂) as well as a combination of elements selected from two or more classes (e.g., Y₁ and Z₀).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present invention will become apparent to those skilled in the art upon consideration of the embodiment descriptions provided hereinbelow.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1A is a block diagram of a remote door locking system according to at least one embodiment of the present disclosure;

FIG. 1B is a block diagram of an alternative remote door locking system according to at least one embodiment of the present disclosure;

FIG. 1C is a block diagram of an alternative remote door locking system according to at least one embodiment of the present disclosure;

FIG. 2A is an illustration of a remote door locking system according to at least one embodiment of the present disclosure;

FIG. 2B is another illustration of a remote door locking system according to at least one embodiment of the present disclosure;

FIG. 3A is a schematic diagram of a remote door locking system according to at least one embodiment of the present disclosure;

FIG. 3B is a schematic diagram of a portion of the remote door locking system according to at least one embodiment of the present disclosure;

FIG. 3C is a schematic diagram of another portion of the remote door locking system according to at least one embodiment of the present disclosure;

FIG. 3D is a schematic diagram of another portion of the remote door locking system according to at least one embodiment of the present disclosure;

FIG. 4 is a circuit diagram of a logic relay circuit of the remote door locking system according to at least one embodiment of the present disclosure;

FIG. 5A is a schematic diagram of another remote door locking system according to at least one embodiment of the present disclosure;

FIG. 5B is a schematic diagram of a portion of the remote door locking system according to at least one embodiment of the present disclosure;

FIG. 5C is a schematic diagram of another portion of the remote door locking system according to at least one embodiment of the present disclosure;

FIG. 5D is a schematic diagram of another portion of the remote door locking system according to at least one embodiment of the present disclosure;

FIG. 6 is a schematic diagram of a portion of another remote door locking system according to at least one embodiment of the present disclosure;

FIG. 7 is a flowchart according to at least one embodiment of the present disclosure; and

FIG. 8 is a flowchart according to at least one embodiment of the present disclosure.

### DETAILED DESCRIPTION

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a remote door locking system.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

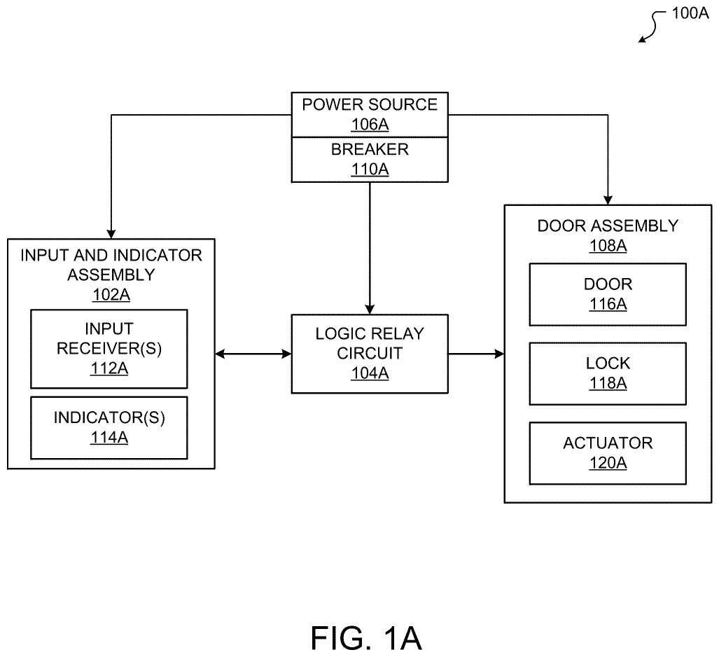

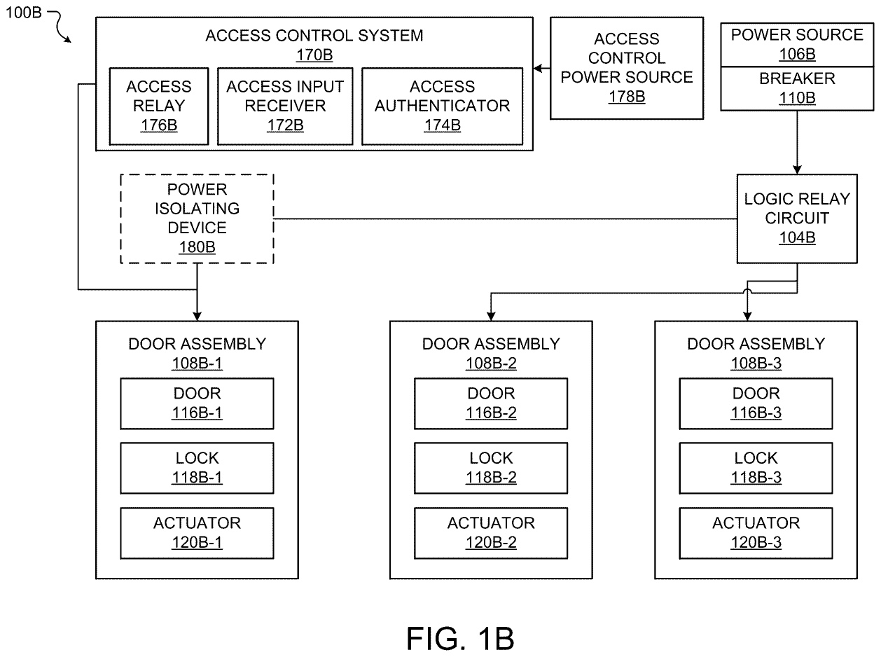

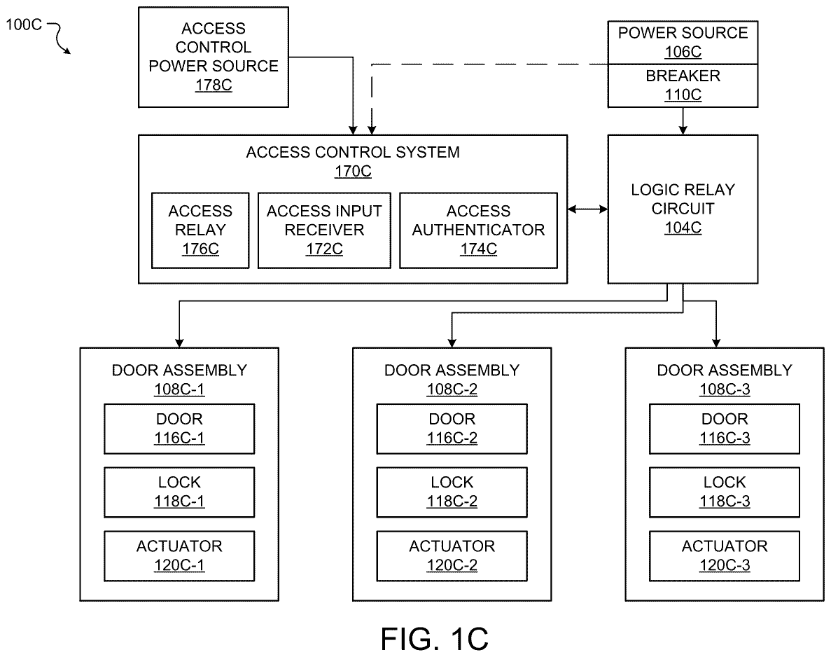

FIG. 1A is a block diagram of a remote door locking system (100A) (the “system”). The system (100A) can be remotely moved from an unlocked state, in which one or more doors are unlocked, to a locked state, in which the one or more doors are locked by, for example, pressing a button. In other examples, the system (100A) can be used to remotely lock one or more doors by using, for example, a remote wireless button to actuate by remote or Bluetooth®, Wi-Fi, or other electronic interface(s). The system (100A) is useful in emergency situations in which one or more doors need to be locked at the same time from a remote location.

The system (100A) includes an input and indicator assembly (102A), a logic relay circuit (104A), a power source (106A), a breaker (110A), and a door assembly (108A). In some embodiments, the system (100A) may include more or less components. For example, the system (100A) may not include the logic relay circuit (104A) or the breaker (110A).

The input and indicator assembly (102A) is configured to receive input from a user and to provide an indicator to the user that the system (100A) has been activated (e.g., door(s) have been locked) or is deactivate (e.g., door(s) are unlocked). The input and indicator assembly (102A) includes an input receiver (112A) and an indicator (114A). The input receiver (112A) and the indicator (114A) can be housed together in one housing or unit. In other embodiments, the input receiver (112A) and the indicator (114A) may be housed in separate housings or units. The input and indicator assembly (102A) can be positioned anywhere within a building. For example, for a fast-food restaurant, the input and indicator assembly (102A) can be placed at a drive through window, each cashier's station, and/or anywhere that is easily accessible for a user.

The input receiver (112A) is configured to receive input from a user to lock one or more doors (116A) of the system (100A). The input receiver (112A) can be, for example, a switch actuated by a button pressed by a user. In such examples, when pressed, the button may remain in an engaged position until the button is pushed and twisted to retract the button. In other examples, the input receiver (112A) can be a touch screen displaying an option for a user to actuate the input receiver (112A). In still other embodiments, the input receiver (112A) can be any mechanical or electro-mechanical device that can receive a user input to activate or deactivate the system (100A). The system (100A) can include any number of input receivers (112A) and any input receiver (112A) can lock all doors (116A) of the system (100A). For example, the system (100A) may include four input receivers (112A) and two doors (116A). In such example, input received at any one input receiver (112A) may lock both of the two doors (116A). The system can also lock the doors (116A) in a way to prevent entry, yet allow normal exit.

The indicator (114A) is configured to provide an indication of whether door(s) (116A) of the system (100A) are locked or unlocked. The indicator (114A) may include one indicator, two indicators, or more than two indicators. For example, the indicator (114A) may include three indicators for three input receivers (112A). The indicator (114A) may be visual, tactile, audible, or a combination thereof and may trigger additional actions, such as alarms, electronic records/logs, video recording, or any connected auxiliary device that can be triggered by sensing a signal or triggered by sensing a change in a normally open or closed circuit. For example, the indicator (114A) may be an LED light that turns ON/OFF and/or changes color (e.g., can change to red or green). In another example, the indicator (114A) may include a red LED and a green LED. In another example, the indicator (114A) may be a display such as a monitor that displays a visual notice of a status of the system (100A) on the monitor. In still other embodiments, the indicator (114A) may include a dual LED, a series of LEDs, an alarm output to actuate other actions, an alarm signal, a siren, a recorded message, etc.

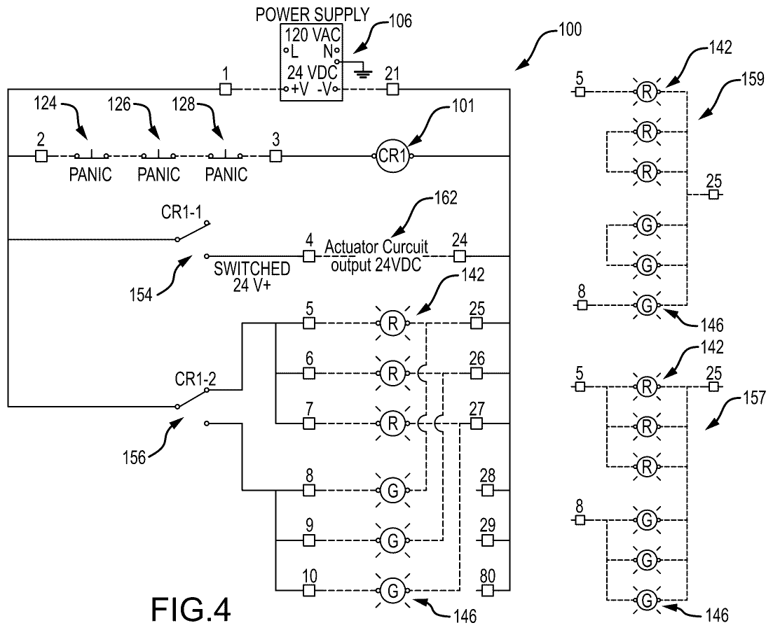

The logic relay circuit (104A) is an electrical circuit that is configured to receive the input from the input receiver (112A) for controlling the system (100A). Based on the input received, the logic relay circuit (104A) triggers an actuator (120A) to lock the door (116A) of the door assembly (108A) and/or provides an indication at the indicator (114A) that the door (116A) is locked. The logic relay circuit (104A) also triggers the actuator (120A) to unlock the door (116A) and provide another indication at the indicator (114A) that the door (116A) is unlocked. The logic relay circuit (104A) may be housed in, for example, a housing and may include one or more LEDs for indicating a status of the logic relay circuit (104A). Use and execution of the logic relay circuit (104A) are described in detail in FIG. 4.

The power source (106A) is configured to provide power to one or more components of the system (100A). As illustrated, the power source (106A) can provide power to the input and indicator assembly (102A), the logic relay circuit (104A), and/or the door assembly (108A) (more specifically, to the actuator (120A)). The power source (106A) can include one power source (106A) to supply power to each component of the system (100A) or can include more than one power source (106A) to supply power to different components of the system (100A). The power source (106A) can supply power from a battery, a generator, an electrical line, or the like. The power source (106A) can also include more than one power sources (106A) where a first power source (106A) can be a primary power source (106A) and a second power source (106A) can be a secondary or backup power source (106A) for the system (100A). In some embodiments, the power source (106A) can be a 24VDC power supply.

The breaker (110A) is configured to prevent damage to the logic relay circuit (104A) by interrupting the power supplied to the logic relay circuit (104A) when the electric current from the power source (106A) exceeds design limitations of the breaker (110A). The breaker (110A) can be single use, or a resettable breaker.

As shown, the door assembly (108A) includes the door (116A), a lock (118A), and the actuator (120A). The door (116A) may be, for example, a push/pull open door, though in other embodiments, the door (116A) may be a sliding door. The door (116A) may also be an emergency door, a fire door, or combination thereof. In any embodiment, the lock (118A) is configured to lock the door (116A) via the actuator (120A). The actuator (120A) may be, for example, a solenoid or a motor that can move the lock (118) between an unlocked position and a locked position. In embodiments where the door (116A) includes a crash bar, the lock (118A) and the actuator (120A) can be mounted inside of the crash bar. In embodiments where the door (116A) is, for example, a glass door or a sliding door, the lock (118A) may be a magnetic lock and the lock (118A), and the actuator (120A) can be mounted on the door (116A) or adjacent to the door (116A). In some embodiments, the door (116A) can be opened from the inside even when the lock (118A) is locked. In such embodiments, the door (116A) may only be opened from the inside, but not the outside to provide a safety egress and exit from the inside while remaining locked from the outside.

In some embodiments, components such as the logic relay circuit (104A), the power source (106A), the indicator (114A), the input receiver (112A), and the actuator (120A) may be hardwired. Such hardwiring is simple to install, cost-effective, and easy to maintain and repair while enabling locking of a door from a remote location.

FIG. 1B is a block diagram of an alternative system (100B) according to at least one embodiment of the present disclosure. The system (100B) shown in FIG. 1B is generally the same as the system shown in FIG. 1A except that the system (100B) includes an access control system (170B), an access control power source (178B), and a power isolating device (180B). Components in FIG. 1B may be the same as or similar to components with like numbers in FIG. 1A. For example, a power source (106B) may be the same as or similar to the power source (106A).

The access control system (170B) enables momentary access to one or more doors when the system (100B) is in a locked state. In the illustrated embodiment, the access control system (170B) is connected to door assembly (108B-1) to enable momentary access to door (116B-1). For example, a user, such as a restaurant manager, can momentarily access the door (116B-1) via the access control system (170B) to enter the building to open the restaurant when the system (100B) is in a locked state.

In other embodiments, the access control system (170B) can enable access to any door(s) such as door(s) (116B-1), (116B-2), or (116B-3). In other words, the system (100B) can include any number of door assemblies (108B) and can include, for example, one door assembly, two door assemblies, or more than two door assemblies. Similarly, the access control system (170B) can be connected to any number of door assemblies (108B) to enable temporary access to any number of doors (116B).

As shown, the access control system (170B) includes an access input receiver (172B), an access authenticator (174B), and an access relay (176B). The access input receiver (170B) is configured to receive input from a user to control access and provide temporary access to one or more doors (116B) when the system (100B) is in a locked state and all doors (116B) are locked and transmit the input to the access authenticator (174B). The input can be transmitted to the access authenticator (174B) via a wired connection, a Wi-Fi connection, BLUETOOTH® connection, or other direct or remote connection.

The access input receiver (170B) can be any device or programmable device capable of receiving one or more inputs from a user. For example, the access input receiver (170B) can include a keypad, a numbered keypad, a digital keypad, a keyboard, a touch screen, a microphone (for receiving audible input), a radio-frequency identification (RFID) reader, a biometric reader, a camera for facial recognition, or combinations thereof.

The access authenticator (174B) is configured to receive the input(s) from the access input receiver (172B), process the input(s), and determine if the input(s) are authorized to access the door (116B-1). In some embodiments, the access authenticator (174B) may receive the input(s), compare the input(s) to authorized target inputs, and determine that the input(s) are authenticated when the input(s) match the authorized target inputs or unauthenticated with the input(s) do not match the authorized target inputs. The access authenticator (174B) is also operable to control the access relay (176A) based on whether the input(s) are authenticated or unauthenticated.

The access authenticator (174) can be on premise (e.g., within or near the system (100B)), remote (e.g., located a distance away from the system (100B)), or hosted in cloud system. The access authenticator (174B) can be, for example, a processor or a programmable logic controller (PLC). The access authenticator (174B) can also include, for example, memory for storing the instructions, input and output components, a programmable interface, etc.

The access relay (176B) is an electrical relay connected to the actuator (120B-1) of the door assembly (108B-1). During use, the access relay (176B) momentarily energizes the actuator (120B-1) to move the door (116B-1) to an unlocked state when the access authenticator (174B) determines that the inputs are authenticated. The access relay (176B) may energize the actuator (120B-1) for any length of time such as, for example, less than one second, between one and ten seconds, or more than ten seconds. After the length of time has passed, the access relay (176B) ceases energizing the actuator (120B-1) and the door (116B-1) returns to a locked state. When the access authenticator (174B) determines that the input(s) are unauthenticated, the access relay (176B) is not energized.

As previously described, the system (100B) also includes the access control power source (178B). The access control power source (178B) may be the same as or similar to the power source (106B), except that the access control power source (178B) supplies power to the access control system (170B). The system (100B) also includes the power isolating device (180B). The power isolating device (180B) can be, for example, a diode or any other device capable of isolating power. The power isolating device (180B) is configured to prevent the access relay (176B) from energizing other door assemblies (108B-2, 108B-3) such that the other door assemblies (108B-2, 108B-3) remain locked when the door assembly (108B-1) is unlocked.

Though not shown, it will be appreciated that the system (100B) can include the input and indicator assembly (102A) of FIG. 1A. In such embodiments, the input and indicator assembly (102A) can also be in communication with the logic relay circuit (104B). In some instances, use of the access control system (170B) does not change the indicators (114A). For example, opening the door (116B-1) via the access control system (170B) will not change an indicator (114A) from a red LED (indicating that the system (100B) is in a locked state) to a green LED (indicating that the system (100B) is in an unlocked state). In other words, the red LED will remain on. In other instances, use of the access control system (170B) can change the indicators (114A). For example, opening the door (116B-1) via the access control system (170B) can change an indicator (114B) from a red LED (indicating that the system (100B) is in a locked state) to a green LED (indicating that the system (100B) is in an unlocked state). When the door (116B-1) is closed and moved to a locked state, the indicator (114A) may change from the green LED to the red LED.

FIG. 1C is a block diagram of an alternative system (100C) according to at least one embodiment of the present disclosure. The system (100C) shown in FIG. 1C is generally the same as the system shown in FIG. 1A except that the system (100C) shown in FIG. 1C includes an access control system (170C) and an access control power source (178C). Components in FIG. 1C may be the same as or similar to components with like numbers in FIG. 1A. For example, a breaker (110C) may be the same as or similar to the breaker (110A).

The access control system (170C) is the same as or similar to the access control system (170B), except that the access control system (170C) is connected to the logic relay circuit (104). The access control system (170C) also includes an access input receiver (172C), which is the same as or similar to the access input receiver (172B), an access authenticator (174C), which is the same as or similar to the access authenticator (174B), and an access relay (176C), which is the same as or similar to the access relay (176B). As shown, the access control system (170C) can be powered by the access control power source (178) and/or the power source (106C).

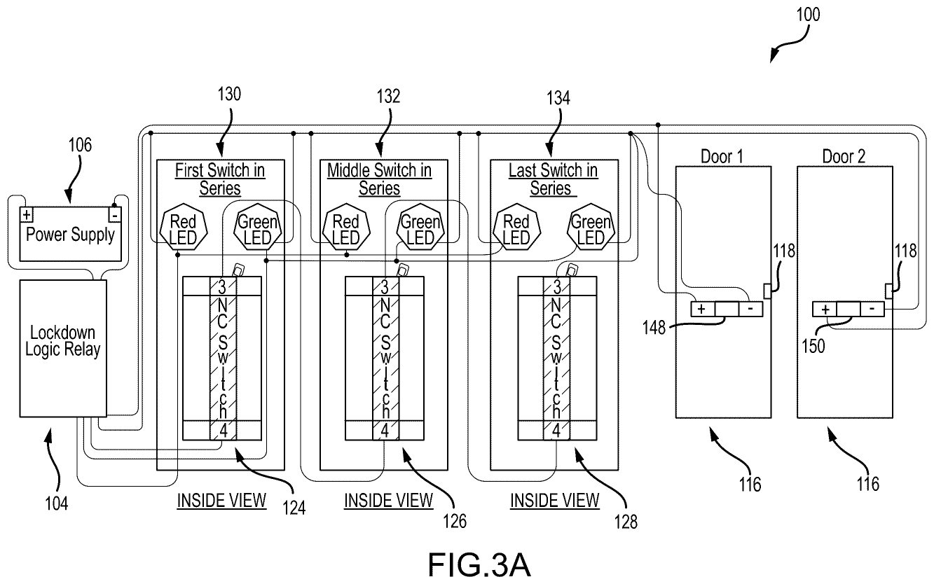

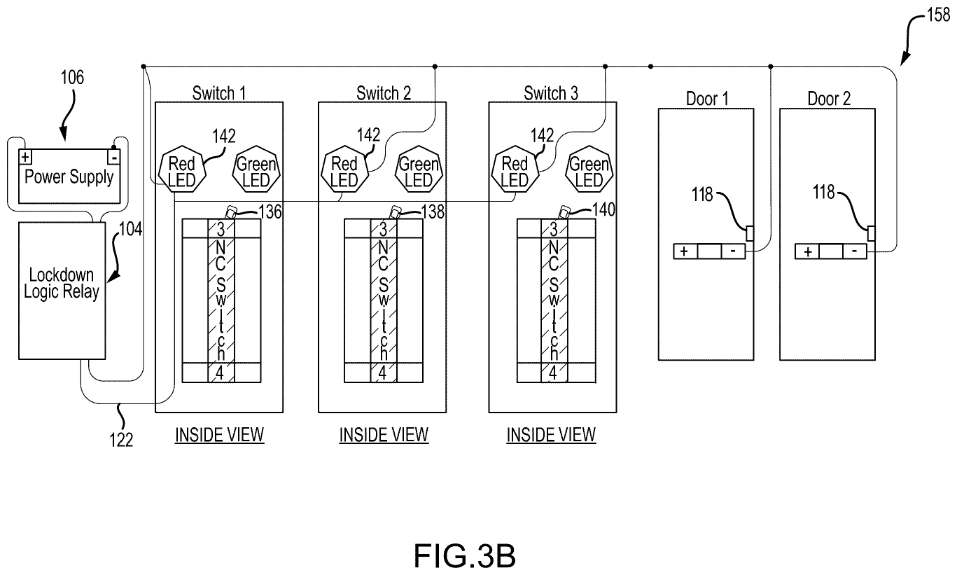

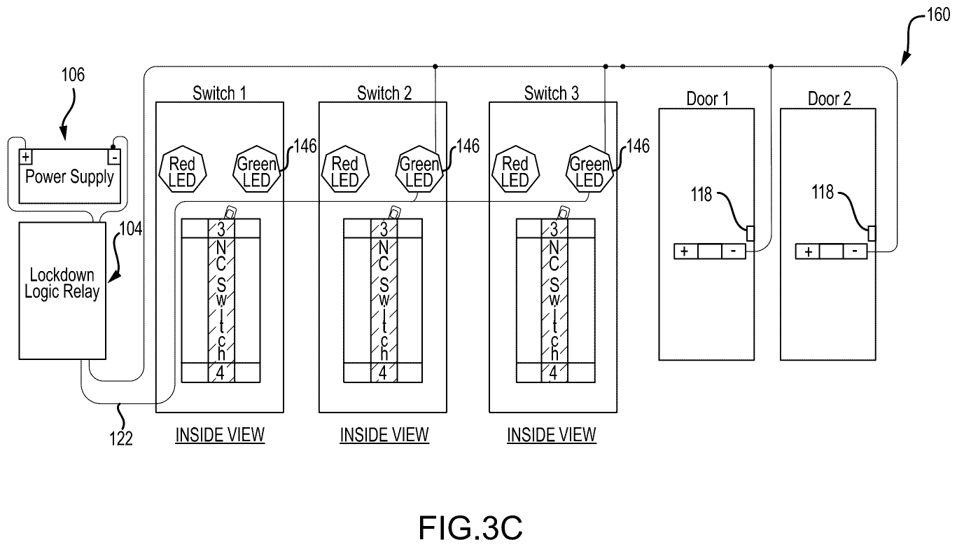

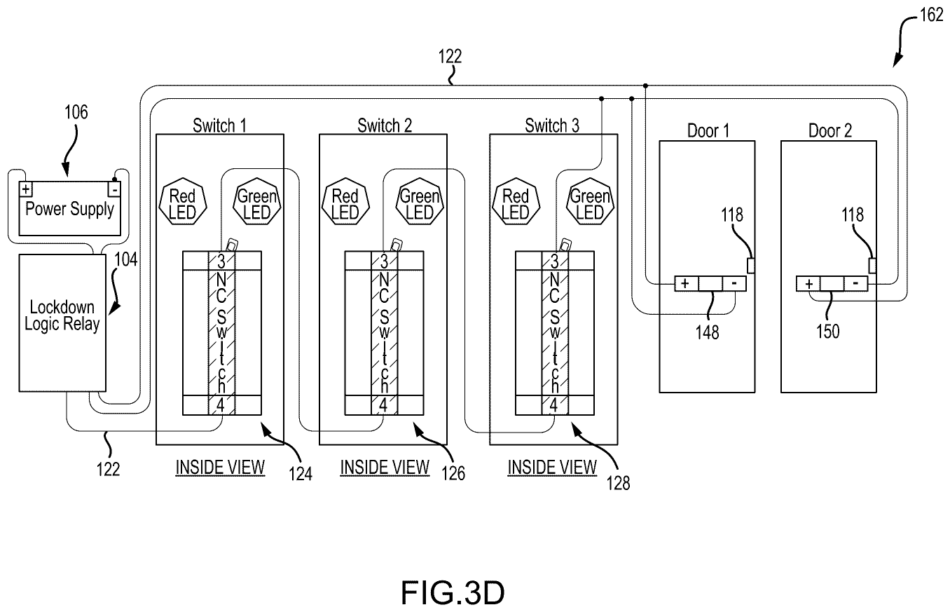

Similarly to the access control system (170B), the access control system (170C) enables temporary access to a target door (e.g., door (116C-1), door (116C-2), or door (116C-3)) via the logic relay circuit (104C). More specifically, the logic relay circuit (104C) receives instructions or controls from the access control system (170C) when input received at the access input receiver (172C) is authenticated by the access authenticator (174C) (as described in FIG. 3B) to transmit an isolated output to the actuator of the target door to unlock the target door. The logic relay circuit (104) may transmit the isolated output for any length of time such as, for example, less than one second, between one and ten seconds, or more than ten seconds.

The logic relay circuit (104C) may also include a power isolating device (180C). The power isolating device (180C) may be an internal isolator to isolate power to the target door and to prevent power from being delivered to other doors. For example, if the target door is the door (116C-1), the logic relay circuit (104C) may output an isolated output to the actuator (120C-1) via the power isolating device (180C) and isolate power from actuators (120C-2), (120C-3) such that doors (116C-2), (116C-3) remain locked while door (116C-1) is unlocked.

It will be appreciated that the system (100C) can include any number of door assemblies (108C) and can include, for example, one door assembly, two door assemblies, or more than two door assemblies. Further, the access control system (170C) can enable temporary access to any number of doors.

Though not shown, it will be appreciated that the system (100C) can include the input and indicator assembly (102A) of FIG. 1A. In such embodiments, the input and indicator assembly (102A) can also be in communication with the logic relay circuit (104C). In some instances, use of the access control system (170C) can change the indicators (114A). For example, opening the door (116C-1) via the access control system (170C) can change an indicator (114A) from a red LED (indicating that the system (100C) is in a locked state) to a green LED (indicating that the system (100C) is in an unlocked state). When the door (116C-1) is closed and moved to a locked state, the indicator (114A) may change from the green LED to the red LED. In other instances, use of the access control system (170C) does not change the indicators (114A). For example, opening the door (116C-1) via the access control system (170C) will not change an indicator (114A) from a red LED (indicating that the system (100C) is in a locked state) to a green LED (indicating that the system (100C) is in an unlocked state). In other words, the red LED will remain on.

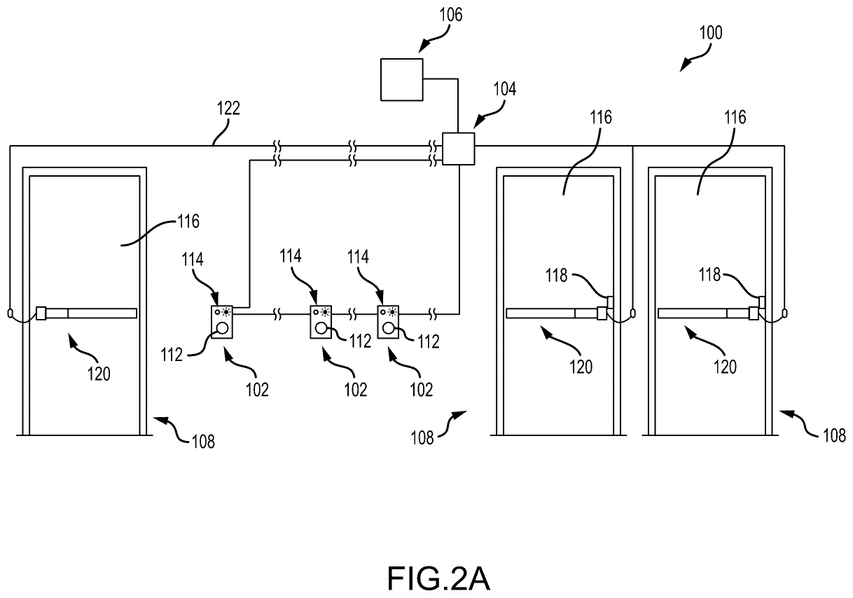

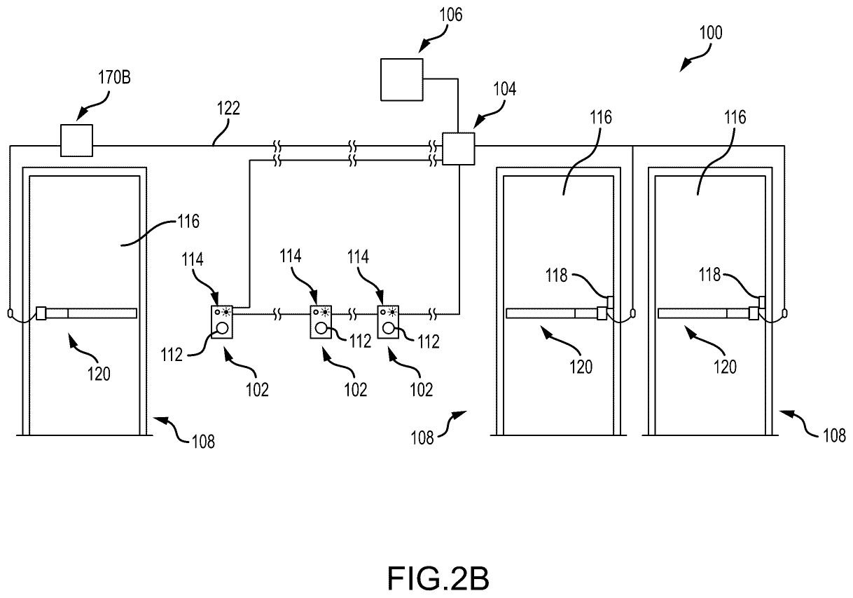

FIGS. 2A and 2B are each an illustration of the system (100) according to at least one embodiment of the present disclosure. FIGS. 2A and 2B are identical except that FIG. 2B includes the access control system (170B) to provide temporary access to the corresponding door (116). As shown, the system (100) includes the logic relay circuit (104) that is connected via wires (122) to the input and indicator assembly (102) and the actuator (120). As shown, for illustrative purposes, the system (100) includes three doors (116) and three corresponding input and indicator assemblies (102). As will be shown and described in the schematic diagrams and the circuit diagram of FIGS. 3A, 3B, 3C, 3D, and 4, input received at any of the input receivers (112) lock all doors (116) and switches all indicators (114) to indicate that the doors (116) are locked.

Turning to FIGS. 3A, 3B, 3C, and 3D, various portions of the system (100) are shown in schematic diagrams. More specifically, FIG. 3A illustrates a schematic diagram for the entire system (100); FIG. 3B illustrates a schematic diagram for a first LED circuit (158). ; FIG. 3C illustrates a schematic diagram for a second LED circuit (160); and FIG. 3D illustrates a schematic diagram for an actuator circuit (162). In FIGS. 3B, 3C, 3D, the wiring for other components is not shown for clarity.

FIG. 3A is a schematic diagram of the system (100) according to at least one embodiment of the present disclosure is provided. As shown, the system (100) includes the power source (106) that supplies power to the logic relay circuit (104). The logic relay circuit (104) is wired to a first switch (124), a first indicator (130), a second switch (126), a second indicator (132), a third switch (128), a third indicator (134), a first actuator (148), and a second actuator (150). The first switch (124), the second switch (126), and the third switch (128) are each a normally closed (NC) switch and are wired in series. The first switch (124), the second switch (126), and the third switch (128) can be actuated by a first button (136), a second button (138), and a third button (140), respectively (labelled in FIG. 3B).

It will be appreciated that in other embodiments, the system (100) can include any number of actuators (120), switches (e.g., input receivers (112)), and indicators (114).

As shown in FIGS. 3B and 3C, the first indicator (130), the second indicator (132), and the third indicator (134) each have a first LED (142) (shown in FIG. 3B) and a second LED (146) (shown in FIG. 3C). The first LED (142) may be, for example, a red LED and the second LED (146) may be, for example, a green LED. It will be appreciated that the first LED (142) and the second LED (146) (or any number of LEDs) can be wired in parallel or in series. As also shown, the logic relay circuit (104) is wired directly to the first indicator (130), the second indicator (132), and the third indicator (134). As will be shown and described in FIG. 4, the logic relay circuit (104) controls the first indicator (130), the second indicator (132), and the third indicator (134) based on the input received at the first switch (124), the second switch (126), or the third switch (128).

As shown in FIG. 3D, the first switch (124), the second switch (126), and the third switch (128) are wired to the logic relay circuit (104) and the logic relay circuit (104) is wired to the first actuator (148) and the second actuator (150). When the first switch (124), the second switch (126), and the third switch (128) (or any switch as the number of switches in series are unlimited) are in the NC position, the first actuator (148) and the second actuator (150) are powered and the corresponding locks (118) are in an unlocked position. When any of the first switch (124), the second switch (126), and the third switch (128) are switched to an open position, both of the first actuator (148) and the second actuator (150) are actuated and lock the corresponding locks (118). In alternative embodiments, when the first actuator (148) and the second actuator (150) are not powered, the corresponding locks (118) may be in a locked position and when the first actuator (148) and the second actuator (150) are powered, the corresponding locks (118) may be in an unlocked position.

FIG. 4 is a circuit diagram of a relay logic of the system (100) according to at least one embodiment of the present disclosure. The logic relay circuit (104) (shown and labeled in FIGS. 1 and 4) is powered by the power source (106). As shown, a control relay (101) controls power to the actuator circuit (162) via a first contact (154) and to the first LEDs (142) and the second LEDs (146) via a second contact (156). Each of the first switch (124), the second switch (126), and the third switch (128) are in a closed position, the first contact (154) for the actuator(s) (120) is in an open switch position, and the second contact (156) is in a closed switch position for the first LEDs (142) and an open switch position for the second LEDs (146). The first contact (154) has the actuator (120) unpowered and thus the lock (118) is in a locked position and the second contact (156) has the first LEDs (142) lit and the second LEDs (146) unlit. As shown, the first LEDs (142) and the second LEDs (146) are in a “home run” configuration. In other embodiments, the first LEDs (142) and the second LEDs (146) may be in a “daisy chain” configuration (158), or any combination of “home run” and/or “daisy chain” configuration. Further, the first LEDs (142) and the second LEDs (146) can be wired in series.

When one of the first switch (124), the second switch (126), or the third switch (128) are switched to an open position, the control relay (101) switches the first contact (154) for the actuator(s) (120) to an open switch position, which interrupts power to the actuator (120) and locks the corresponding locks (118) for each door (116). Further, the second contact (156) switches from the open position to the closed position for the first LEDs (142) and from the closed position to the open position for the second LEDs (146) such that the first LEDs (142) are lit and the second LEDs (146) are unlit. As previously described, switching any one of the first switch (124), the second switch (126), or the third switch (128) causes all actuators (120) to lock the corresponding lock (118) for all doors (116).

In the illustrated embodiment, after the first switch (124), the second switch (126), or the third switch (128) are pressed, the doors (116) can be unlocked by simply releasing the pressed switch. In some embodiments, releasing the pressed switch include pressing or twisting a button connected to the switch to release the switch. After the switch is released and returned to an unpressed state, the actuators (120) are powered, thereby unlocking the corresponding locks (118) and doors (116). Further, the second contact (156) is switched such that the first LEDs (142) are unlit and the second LEDs (146) are lit.

In some embodiments, if the logic relay circuit (104) loses power, then the control relay (101) will automatically depower each actuator (120) to lock each door (116). In other embodiments, the control relay (101) may not lock the doors (116) if the logic relay circuit (104) loses power.

The logic relay circuit (104) uses less wiring than a system without the logic relay circuit (104). Such reduction in wiring beneficially reduces costs (as less wire is needed) and improves installation time as well as repair and maintenance time and costs.

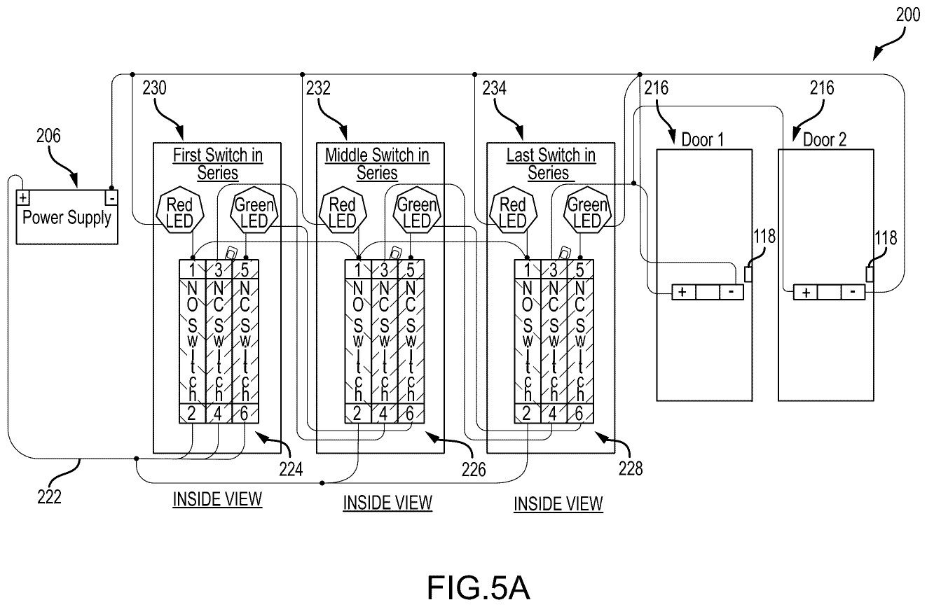

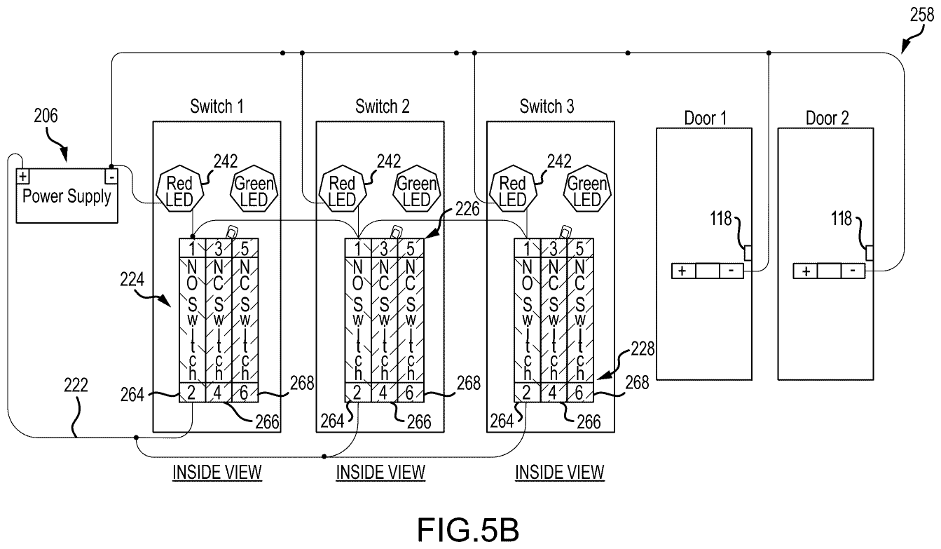

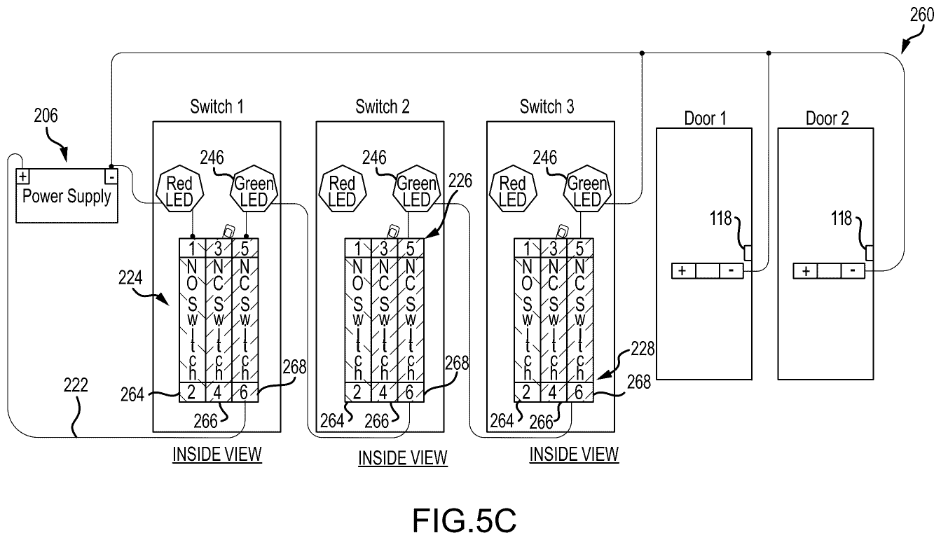

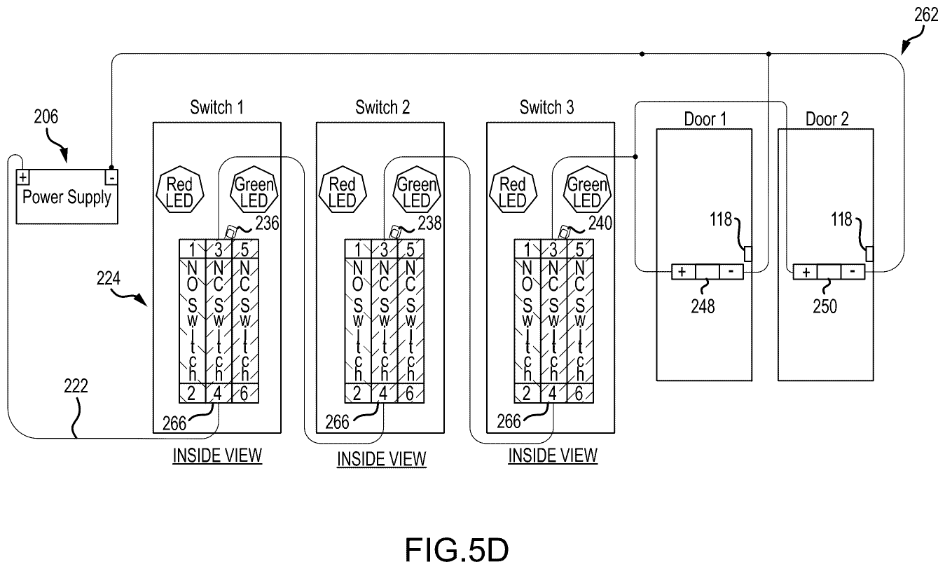

Turning to FIGS. 5A, 5B, 5C, and 5D, various stages of a system (200) are shown in schematic diagrams. More specifically, FIG. 5A illustrates a schematic diagram for a system such as the entire system (200); FIG. 5B illustrates a schematic diagram for a first LED circuit (258); FIG. 5C illustrates a schematic diagram for a second LED circuit (260); and FIG. 5D illustrates a schematic diagram for an actuator circuit (262). In FIGS. 5B, 5C, 5D, the wiring for other components is not shown for clarity.

FIG. 5A is a schematic diagram of another embodiment of a remote door locking system such as the system (200) according to at least one embodiment of the present disclosure. The system (200) is similar to the system (100), except that the system (200) does not include the logic relay circuit (104). As shown, the system (200) includes a power supply (206) wired via wires (222) to a first actuator (248), a second actuator (250), a first indicator (230), a second indicator (232), a third indicator (234), a first set of switches (224), a second set of switches (226), and a third set of switches (228).

As shown in FIGS. 5B and 5C, each of the first indicator (230), the second indicator (232), and the third indicator (234) include a first LED (242) and a second LED (246). Further, each of the first set of switches (224), the second set of switches (226), and the third set of switches (228) include a first switch (264) in a normally open (NO) position and wired to the first LED (242), a second switch (266) in a NC position, and a third switch (268) in a NC position and wired to the second LED (246).

As shown in FIG. 5D, the second switch (266) is in the NC position and wired to the first actuator (248) and the second actuator (250). Thus, if any of the first set of switches (230), the second set of switches (232), and the third set of switches (234) are pressed or switched, both the first actuator (248) and the second actuator (250) are actuated to lock the corresponding doors (216). Further, if any of the first set of switches (230), the second set of switches (232), and the third set of switches (234) are pressed or switched, the first LED (242) will become unlit and the second LED (246) will be lit.

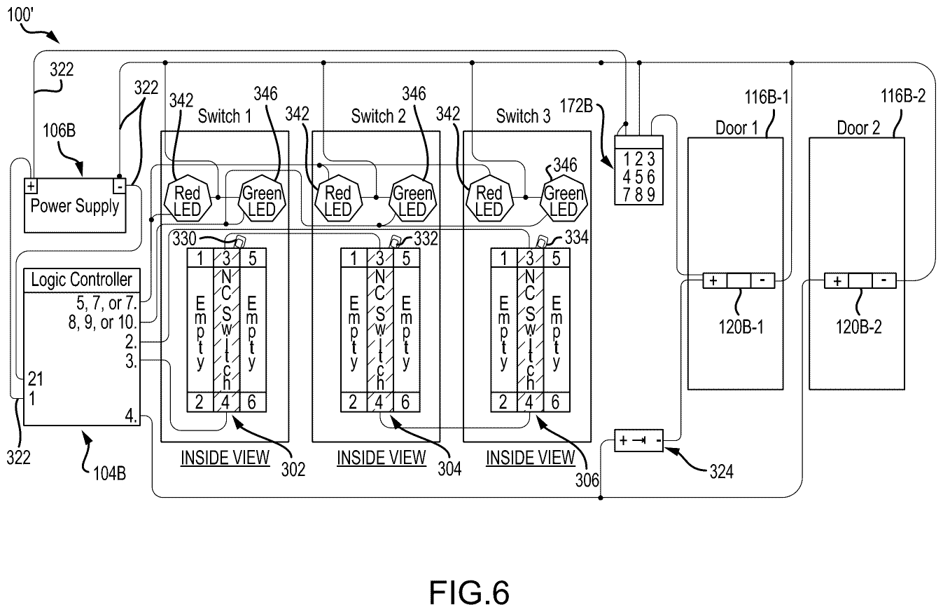

Turning to FIG. 6, a schematic diagram of the system (100B) of FIG. 1B according to at least one embodiment is shown. As shown, the system (100B) includes the power source (106B) wired via wires (322) to a first switch (302), a second switch (304), a third switch (306), a logic relay circuit (104B), an access control system (172B), a first actuator (120B-1), and a second actuator (120B-2). It will be appreciated that the system (100B) can include more or less than three switches, more than one access control systems (172B), more than one logic relay circuits (104B), and more or less than two actuators (and corresponding locks and doors).

The logic relay circuit (104B) is also wired to the first switch (302), the second switch (304), the third switch (306), the access control system (172B), and a diode (324). A first indicator (342) and a second indicator (346) of each of the first switch (302), the second switch (304), the third switch (306) are also wired to the logic relay circuit (104B) and the power supply (106B).

Similarly to the system (100) shown in FIGS. 3A-3D, the first switch (302), the second switch (304), and the third switch (306) are each a normally closed (NC) switch and are wired in series. The first switch (302), the second switch (304), and the third switch (306) can be actuated by a first button (330), a second button (332), and a third button (334), respectively.

It will be appreciated that in some embodiments, a key can also be used to open any door (116B-1), (116B-2) when the system (100B) is in a locked state (e.g., a switch is depressed and all doors (116B-1), (116B-2) are locked).

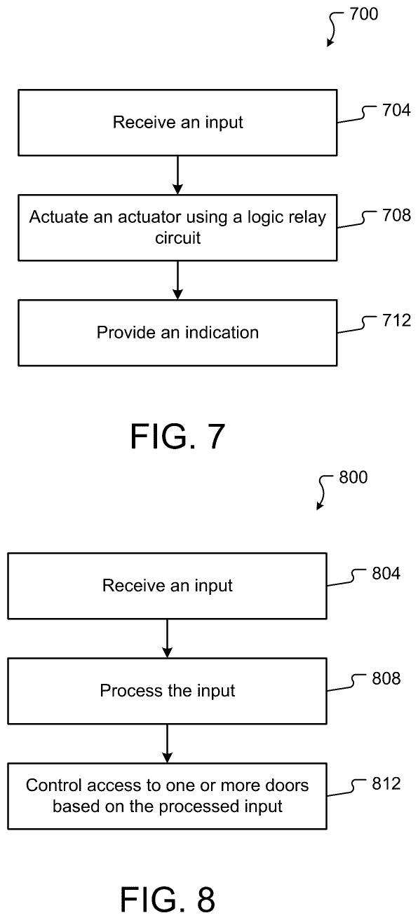

Turning to FIG. 7, a method (700) for using a remote door locking system such as the system (100A), (200) described above is provided. At step 704, an input may be received at, for example, an input receiver such as the input receiver (112A) of an input and indicator assembly such as the input and indicator assembly (102A). The input may be, for example, a user pressing a button connected to a switch.

At step 708, an actuator such as the actuator (120A) of a door assembly such as the door assembly (108) may be actuated by a logic relay circuit such as the logic relay circuit (104A) based on the input. The actuator moves a lock such as the lock (118A) of a door such as the door (116A) between a locked position and an unlocked position. When the input is such that moves the switch from a NC position to an open position, the actuator moves the lock from the unlocked position to the locked position. Similarly, when the input is such that moves the switch from the open position back to the NC position, the actuator moves the lock from the locked position to the unlocked position. In at least one embodiment, while the lock is in the locked position, the lock is still able to be opened from one direction (e.g., from inside of the building) to allow personnel inside of the building to exit in all conditions. In other words, egress is always allowed.

At step 712, an indication is provided at an indicator such as the indicator (114A). The indicator may be, for example, a red LED and a green LED. When the door is unlocked, the green LED may be lit while the red LED is unlit and when the door is locked, the green LED may be unlit and the red LED may be lit.

The method (700) described above may include more or less steps. Further, any steps of the method (700) may be repeated.

Turning to FIG. 8, a method (800) for using an access control system such as the access control system (170B), (170C) is provided.

At step 804, an input may be received at, for example, an access input receiver such as the access input receiver (172B), (172C) of the access control system. As previously described, the access input receiver may be a keypad, a numbered keypad, a digital keypad, a keyboard, a touch screen, a microphone (for receiving audible input), a RFID reader, a biometric reader, a camera for facial recognition, or combinations thereof and inputs can be transmitted via a wired connection, a Wi-Fi connection, BLUETOOTH® connection, or other direct or remote connection to an access authenticator such as the access authenticator (174) of the access control system.

The input may be a combination of alphanumeric characters, a combination of numeric characters, a combination of alphabetic characters, a biometric input, an image (from a camera), an RFID card or transmitter.

At step 808, the input is processed. The input may be processed (and received) by the access authenticator to determine if the input is authenticated or unauthenticated. The input is authenticated when the input matches a target input and is unauthenticated when the input does not match the target input. For example, an input of “123456” matches a target input of “123456” and is determined to be authenticated. In another example, an input of “123678” does not match the target input of “123456” and the input is unauthenticated.

At step 812, access to one or more doors is controlled based on the input processed in the step 808. More specifically, an access relay such as the access relay (176C) is connected to one or more target actuators such as actuators (120B-1), (120C-1). During use, the access relay energizes the target actuator for a predetermined time period to unlock a corresponding door, such as the door (116B-1), (116C-1) when the input is authenticated. The access relay does not energize the target actuator when the input is unauthenticated.

The method (800) described above may include more or less steps. Further, any steps of the method (800) may be repeated.

The remote locking door system (100A), (100B), (100C), (200) as described above enable a user to lock one or more doors from a remote location. This is beneficial in situations where multiple doors of a building need to be locked to prevent a person from entering the building from outside of the building. For example, the building may be a fast-food restaurant that has four doors at various locations of the building. In the event that a customer becomes threatening while outside of the building, a worker inside of the building can press a button to lock all doors and prevent the customer from entering the building, eliminating the need for the worker to go to each door with a dogging key or other locking procedure. In other embodiments, the remote locking door system (100A), (100B), (100C), (200) can be used to simply lock all doors after the building has been closed. For example, if one worker is closing the building, they can simply press the button to lock all doors, then leave through the door (in instances where the door can still be opened from the inside while being locked from the outside) or momentarily un-locked and opened from the outside with their access fob or key. Further, the system (100A), (100B), (100C), (200) is designed for easy installation in buildings using the existing doors and existing keys or fobs with minimal changes to the infrastructure at a low cost. The system (100A), (100B), (100C), (200) also enables normal use of the door with exterior access, while added extra safety and security to the door.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A remote door locking system comprising:
an input and indicator assembly configured to receive input and provide an indication of whether a door is locked or unlocked;
a door assembly having the door, a lock configured to lock the door, and an actuator configured to move the lock between an unlocked position and a locked position, while maintaining an emergency exit function; and
a logic relay circuit configured to actuate the actuator to move the lock from the unlocked position to the locked position when the input is received at the input and indicator assembly.

2. The remote door locking system of claim 1, wherein the logic relay circuit is further configured to provide the indication that corresponds to the door being locked.

3. The remote door locking system of claim 1, wherein the input and indicator assembly includes an input receiver and an indicator.

4. The remote door locking system of claim 3, wherein the input receiver includes a button connected to a switch in a normally closed position, wherein pressing the button moves the switch from the normally closed position to an open position, and wherein the button is at least one of wired to the switch or includes a wireless transmitter wired to the switch.

5. The remote door locking system of claim 3, wherein the indictor includes at least one of a first LED and a second LED, a dual LED, a series of LEDs, an electronic signal, an audible signal, or a visual signal.

6. The remote door locking system of claim 5, wherein the logic relay circuit includes a control relay that controls power to an actuator circuit that powers the actuator via a first contact and that controls power to the first LED and the second LED, or any number of LEDs, via a second contact, or any number of contacts.

7. The remote door locking system of claim 6, wherein the first contact is in a closed switch position and the second contact is in an open switch position for the first LED and in a closed switch position for the second LED when the input receiver has not received the input, and wherein the lock is in an unlocked position, the first LED is unlit, and the second LED is lit.

8. The remote door locking system of claim 6, wherein the first contact is in an open switch position and the second contact is in a closed switch position for the first LED and in an open switch position for the second LED when the input receiver has received the input, and wherein the lock is in a locked position, the first LED is lit, and the second LED is unlit.

9. The remote door locking system of claim 5, wherein the first LED is a red LED and the second LED is a green LED.

10. The remote door locking system of claim 9, wherein the green LED indicates that the door is unlocked and the red LED indicates that the door is locked.

11. The remote door locking system of claim 1, further comprising an access control system configured to control access to the door based on an input received at an access input receiver and a determination of whether the input is authenticated or unauthenticated wherein the access to door is limited to a predetermined time period.

12. The remote door locking system of claim 1, further comprising a power source configured to provide power to the logic relay circuit, the input and indicator assembly, and the actuator.

13. The remote door locking system of claim 1, wherein the input and indicator assembly, the logic relay circuit, and the door assembly are hardwired.

14. A method of locking a door from a remote location, the method comprising:
receiving input at an input and indicator assembly;
actuating an actuator by a logic relay circuit based on the input received, wherein actuating the actuator moves a lock from an unlocked position to a locked position to lock a door; and
providing an indication that the door is locked from the input and indicator assembly.

15. The method of locking the door from the remote location of claim 14, wherein the input and indicator assembly includes an input receiver and an indicator.

16. The method of locking the door from the remote location of claim 15, wherein the input receiver includes a button connected to a switch in a normally closed position, and wherein pressing the button moves the switch from the normally closed position to an open position.

17. The method of locking the door from the remote location of claim 16, wherein the indictor includes a first LED and a second LED.

18. The method of locking the door from the remote location of claim 17, wherein the control relay circuit includes a control relay that controls power to an actuator circuit that powers the actuator via a first contact and that controls power to the first LED and the second LED via a second contact.

19. The method of locking the door from the remote location of claim 18, wherein the first contact is in a closed switch position and the second contact is in an open switch position for the first LED and in a closed switch position for the second LED when the input receiver has not received the input, and wherein the lock is in an unlocked position, the first LED is unlit, and the second LED is lit.

20. The method of locking the door from the remote location of claim 18, wherein the first contact is in an open switch position and the second contact is in a closed switch position for the first LED and in an open switch position for the second LED when the input receiver has received the input, and wherein the lock is in a locked position, the first LED is lit, and the second LED is unlit.
